(19) United States
(12) Patent Application Publication
(10) Pub. No.: US 2003/0039451 A1
(43) Pub. Date: Feb. 27, 2003

(54) Plug for an optical fiber

(76) Inventor: Yu-Feng Cheng, Tucheng City (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/938,998

(22) Filed: Aug. 24, 2001

(51) Int. Cl. G02B 6/36

(52) U.S. Cl. 385/78

(57) ABSTRACT

A plug for an optical fiber has an inner tube for receiving an optical fiber. A middle tube covers the inner tube and is formed by injection molding. The middle tube has an insulating front part covering a front end of the inner tube. An outer tube covers the middle tube.

### BACKGROUND OF THE INVENTION

1. Field of the Invention

The present invention is related to a plug for an optical fiber, and more particular to a plug of which a manufacturing procedure is simplified.

2. Description of Related Art

A joint to connect two optical fibers has a plug provided at an end of an optical fiber. Referring to FIGS. 6 and 7, a conventional plug has an inner tube (91) for receiving an optical fiber (90) therein. An insulating tube (911) is formed at a middle of the inner tube (91) by injection molding and a plurality of rings (910) is formed at a rear end of the inner tube (91). A middle tube (93) is formed at the rear end of the inner tube (91) and has a flange (930) formed thereon, as shown in FIG. 8. An outer tube (92) covers the middle tube (93) and is secured to the middle tube (93) by the flange (930).

In manufacturing, the optical fiber (90) is first inserted through the outer tube (92) and inserted in the inner tube (91) via a rear end of the inner tube (91). Afterwards, the rings (910) are deformed by punching for securing the optical fiber (90) in the inner tube (91). Thereafter, the middle tube (93) is formed on the inner tube (91) by injection molding. The outer tube (92) is moved forwards to cover the middle tube (93).

In this process, there are two procedures of injection molding, wherein the first one is for forming the insulating tube (911), and the second one is for forming the middle tube (93). Thus, the manufacturing process is complex and the cost of the plug is high.

Therefore, the invention provides a plug for an optical fiber to mitigate and/or obviate the aforementioned problems.

### SUMMARY OF THE INVENTION

The main objective of the invention is to provide a plug for an optical fiber of which a manufacturing process is simplified.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a plug for an optical fiber in accordance with the invention;

FIG. 2 is a perspective view of the plug in assembly partially;

FIG. 3 is a cross sectional view of the plug of FIG. 2;

FIG. 4 is a cross sectional view of the plug after being punched;

FIG. 5 is a perspective view showing the plug being assembled completely;

FIG. 6 is a perspective view of a conventional plug for an optical fiber;

FIG. 7 is an exploded perspective view showing the conventional plug in the first procedure; and

FIG. 8 is an exploded perspective view showing the conventional plug in the second procedure.

### DETAILED DESCRIPTION OF THE PREFERRED EMBODIMENT

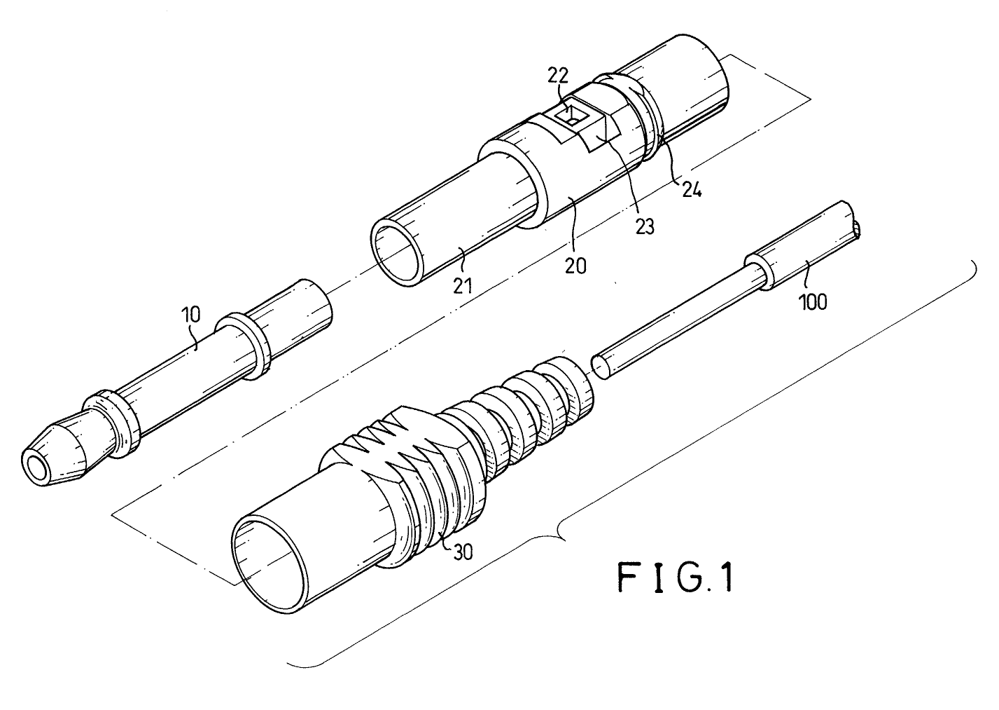

Referring to FIG. 1, a plug for an optical fiber in accordance with the invention is composed of an inner tube (10) for receiving an optical fiber (100), a middle tube (20) covering the inner tube (10), and an outer tube (30) covering the middle tube (20).

The middle tube (20) is made by injection molding and has an insulating front part (21) covering the inner tube (10). A punching hole (22) is radially defined at a middle portion of the middle tube (20) and aligned with a rear end of the inner tube (10). Two openings (23) are respectively defined beside the punching hole (22) for positioning a punching tool (not shown or numbered). A flange (24) is formed at a rear end of the middle tube (20).

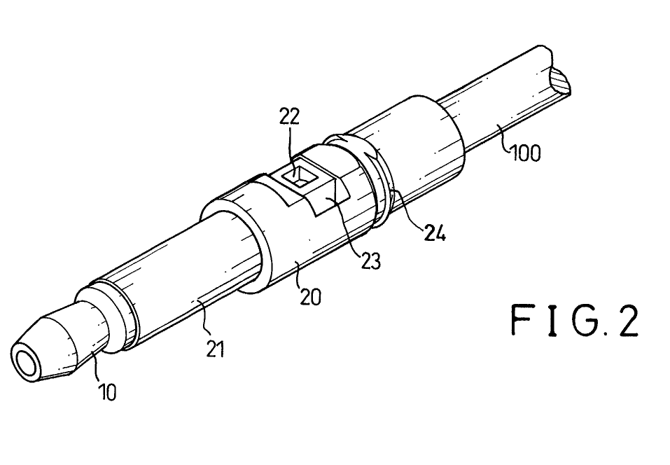

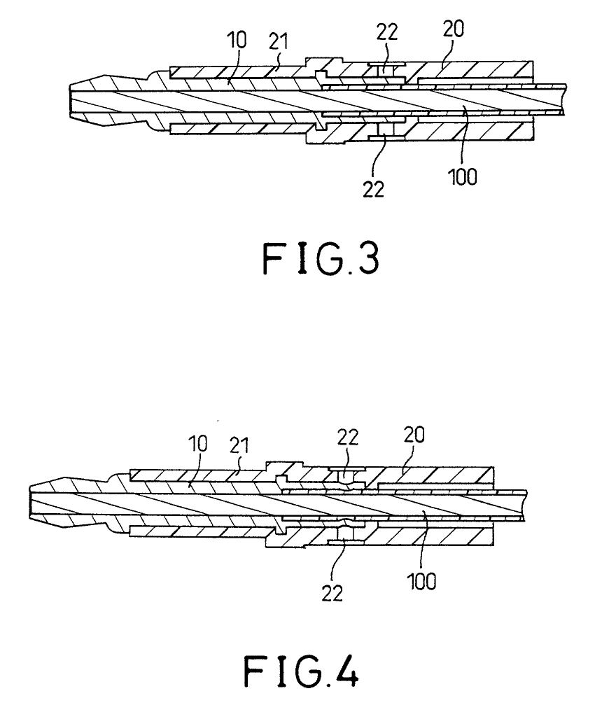

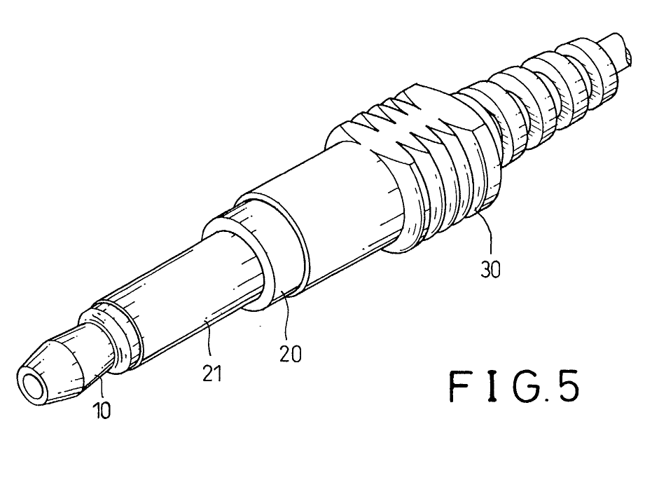

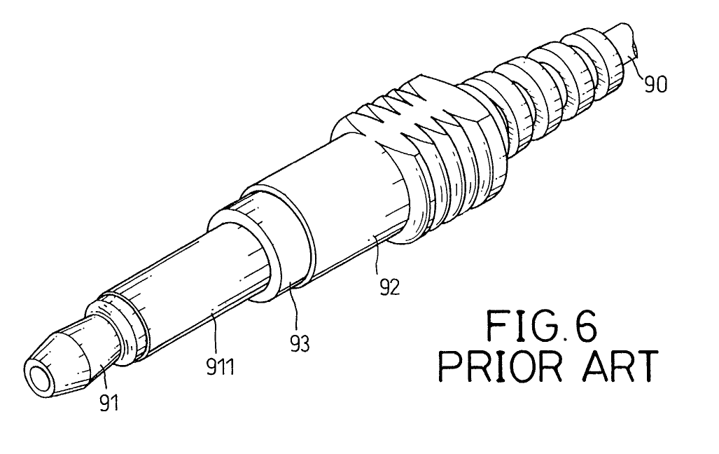

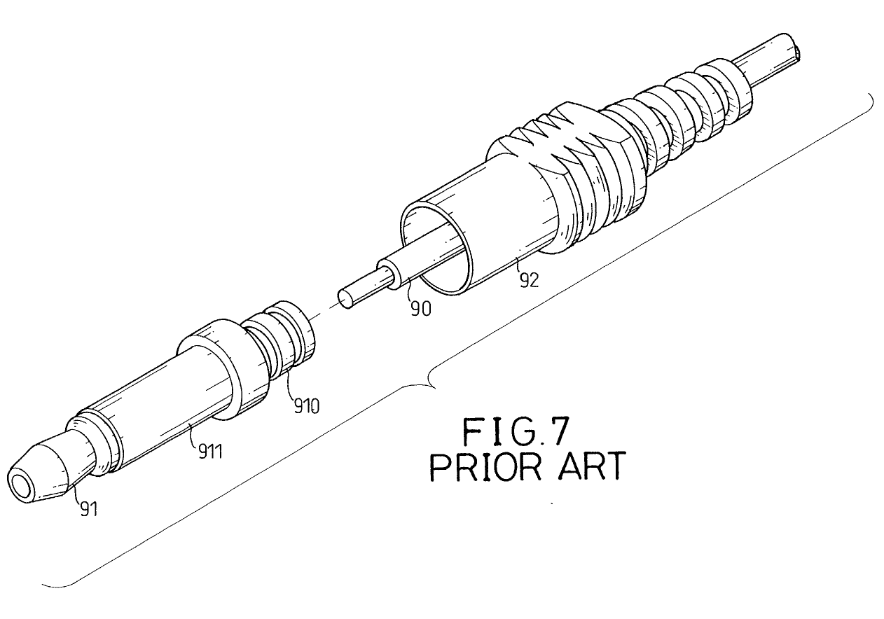

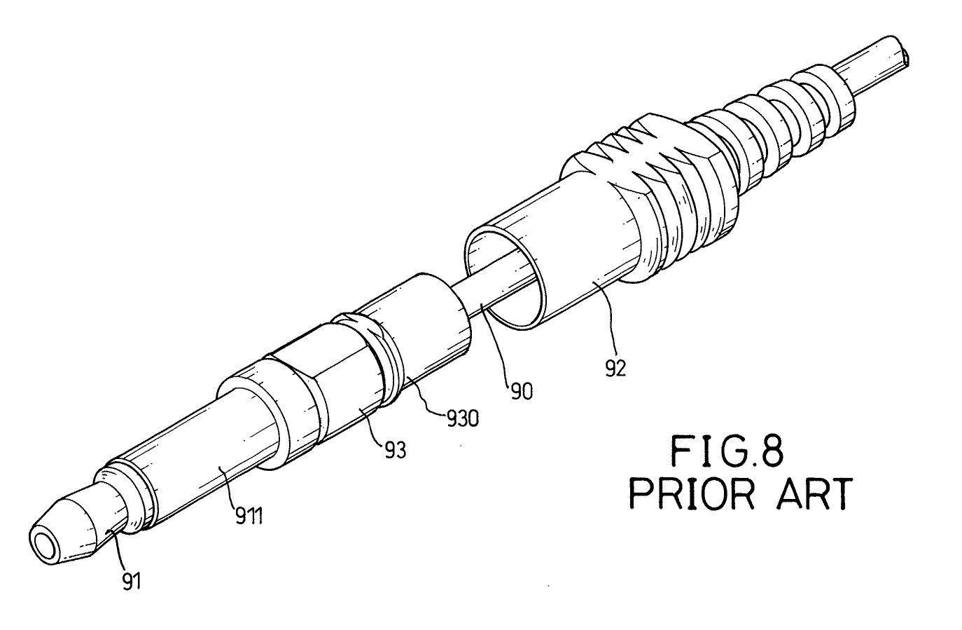

In manufacturing, referring to FIGS. 2 and 3, the middle tube (20) is directly formed on the inner tube (10) by injection molding and the optical fiber (100) passing through the outer tube (30) is inserted in the inner tube (10) via a rear end of the middle tube (20). Afterwards, the inner tube (10) is deformed by punching via a punch device locating with the punching hole (22) and the optical fiber (100) is tightly secured in the inner tube (10), as shown in FIG. 4. Thereafter, the outer tube (30) is moved forwards to cover the punching hole (22) and the openings (23) of the middle tube (20) and is fastened on the middle tube (20) by the flange (24). The completed plug in accordance with the invention is shown in FIG. 5.

According to the present invention, because the insulating front part (21) is integrated with the middle tube (20), there is only one procedure of injection molding for forming the middle tube (20) on the inner tube (10). Therefore, the manufacturing process is simple and the cost is low.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug for an optical fiber comprising:
an inner tube (10) for receiving an optical fiber (100); and
a middle tube (20) covering the inner tube (10) and formed by injection molding, the middle tube (20) having an insulating front part (21) covering a front end of the inner tube (10).

2. The plug as claimed in claim 1, wherein the middle tube (20) has at least one punching hole (22) radially defined therethrough and aligned with a rear end of the inner tube (10).

3. The plug as claimed in claim 2, wherein the middle tube (20) has two openings (24) defined besides the punching hole (22).

4. A plug for an optical fiber comprising:
an inner tube (10) for receiving an optical fiber (100);
a middle tube (20) covering the inner tube (10) and formed by injection molding, the middle tube (20) having an insulating front part (21) covering a front end of the inner tube (10); and
an outer tube (30) covering the middle tube (20).

5. The plug as claimed in claim 4, wherein the middle tube (20) has at least one punching hole (22) radially defined therethrough and aligned with a rear end of the inner tube (10).

6. The plug as claimed in claim 5, wherein the middle tube (20) has two openings (24) defined besides the punching hole (22).

7. The plug as claimed in claim 4, wherein the middle tube (20) has a flange (24) formed at a rear end thereof for tightly securing the outer tube (30) to the middle tube (20).
